(19) United States
(12) Patent Application Publication
(10) Pub. No.: US 2004/0083094 A1
(43) Pub. Date: Apr. 29, 2004

(54) Wavelet-based compression and decompression of audio sample sets

(75) Inventors: Daniel L. Zelazo, Kasiwa-shi (JP); Steven D. Trautmann, Tsukuba (JP)

Correspondence Address: TEXAS INSTRUMENTS INCORPORATED, P O BOX 655474, M/S 3999, DALLAS, TX, 75265

(73) Assignee: Texas Instruments Incorporated

(21) Appl. No.: 10/283,385

(22) Filed: Oct. 29, 2002

(51) Int. Cl. G10L 19/00

(52) U.S. Cl. 704/212

(57) ABSTRACT

A system is provided for wavelet-based compression of an audio sample set including multiple audio samples. For each of the audio samples, the system receives the audio sample and, according to a psychoacoustic model, determines perceptually important information in the audio sample. The system decomposes the audio sample into multiple sub-bands according to a Wavelet Packet Transform and allocates bits to each of the sub-bands of the audio sample according to the determined perceptually important information in the audio sample. The system compresses the audio sample according to the allocation of bits to the sub-bands. The plurality of compressed audio samples includes a compressed audio sample set usable to generate a plurality of synthesized audio signals.

### TECHNICAL FIELD OF THE INVENTION

This invention relates generally to compression and decompression of audio sample sets and more particularly to wavelet-based compression and decompression of audio sample sets.

### BACKGROUND OF THE INVENTION

Wavetable music synthesis and many types of voice synthesis use pulse code modulated (PCM) audio samples of particular sounds, such as those made by musical instruments or human beings, that are stored in digital form in a sample set. When a particular sound is called for during operation of a device, the appropriate audio sample is retrieved from the sample set for playback. Additional techniques, which include the use of filters, envelopes, and low frequency oscillators (LFOs), may be applied to the data. However, to produce high quality synthesis, typically several megabytes are still required to store the complete audio sample set. For portable devices such as mobile telephones, electronic toys, and other hand-held devices, this can be a difficult memory requirement to accommodate.

### SUMMARY OF THE INVENTION

Particular embodiments of the present invention may reduce or eliminate disadvantages and problems traditionally associated with compressing and decompressing audio sample sets.

In one embodiment of the present invention, a system is provided for wavelet-based compression of an audio sample set including multiple audio samples. For each of the audio samples, the system receives the audio sample and, according to a psychoacoustic model, determines perceptually important information in the audio sample. The system decomposes the audio sample into multiple sub-bands according to a Wavelet Packet Transform and allocates bits to each of the sub-bands of the audio sample according to the determined perceptually important information in the audio sample. The system compresses the audio sample according to the allocation of bits to the sub-bands. The plurality of compressed audio samples includes a compressed audio sample set usable to generate a plurality of synthesized audio signals.

In another embodiment of the present invention, a system is provided for wavelet-based decompression of a compressed audio sample. The system receives a request for a decompressed audio sample. The decompressed audio sample corresponds to the compressed audio sample. The compressed audio sample has been compressed by determining perceptually important information in a received audio sample according to a psychoacoustic model, decomposing the received audio sample into multiple sub-bands according to a Wavelet Packet Transform, allocating bits to each of the sub-bands of the received audio sample according to the determined perceptually important information in the received audio sample, and compressing the received audio sample according to the allocation of bits to the sub-bands. The system retrieves the compressed audio sample from a compressed audio sample set comprising multiple similarly compressed audio samples, unpacks the retrieved compressed audio sample, and composes the decompressed audio sample from the plurality of sub-bands according to an inverse Wavelet Packet Transform for use in generating a synthesized audio signal.

Particular embodiments of the present invention may provide one or more technical advantages. In particular embodiments, an audio sample may be compressed to ease memory constraints while, at the same time, maintaining perceptual integrity and real-time performance of music synthesis and similar applications. In particular embodiments, wavelets, psychoacoustic modeling, and possibly other techniques may be used to compress audio sample data. In particular embodiments, wavelets may be used instead of Fast Fourier Transforms (FFTs) to compress data, which may provide faster decoding. In particular embodiments, such decoding may be on the order of N computations instead of Nlog(N) computations. Particular embodiments may be applied to the storage of a library of audio samples. Certain embodiments may provide all, some, or none of these technical advantages, and certain embodiments may provide one or more other technical advantages which may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example Wavetablet coder;

FIG. 2 illustrates an example tree structure;

FIG. 3 illustrates an example wavelet tree decomposition;

FIG. 4 illustrates an example parallel filter bank;

FIG. 5 illustrates an example method for wavelet-based compression of an audio sample;

FIG. 6 illustrates an example Wavetablet decoder;

FIG. 7 illustrates an example method for wavelet-based decompression of a requested audio sample; and

FIG. 8 illustrates an example Musical Instrument Digital Interface (MIDI) system using a Wavetablet decoder.

### DESCRIPTION OF EXAMPLE EMBODIMENTS

1. ENCODER

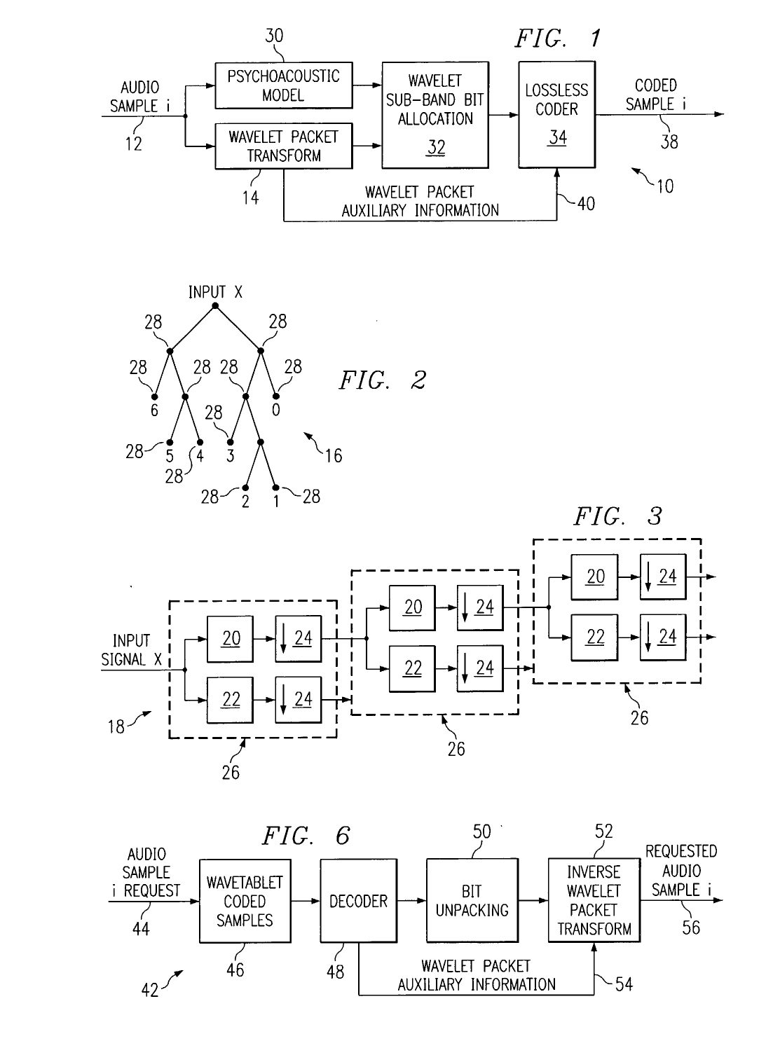

FIG. 1 illustrates an example Wavetablet coder 10. A PCM audio sample 12 from a set of samples is decomposed using a Wavelet Packet Transform 14. Wavelet Packet Transform 14 may be used to decompose audio sample 12 into multiple sub-bands using an arbitrary tree structure 16 of low-pass and high-pass filters, such as example tree structure 16 illustrated in FIG. 2. FIG. 3 illustrates an example wavelet tree decomposition 18, which includes a dyadic tree structure that iterates only low-pass channels. This tree structure is referred to as the Wavelet Transform. An input sample may be passed through a series of complementary low-pass filters 20 and high-pass filters 22 followed by decimators 24. At each stage in wavelet tree decomposition 18, the input sample may be broken down into two components: a low-pass, or coarse part; and a high-pass, or detailed part. These two components may be complementary.

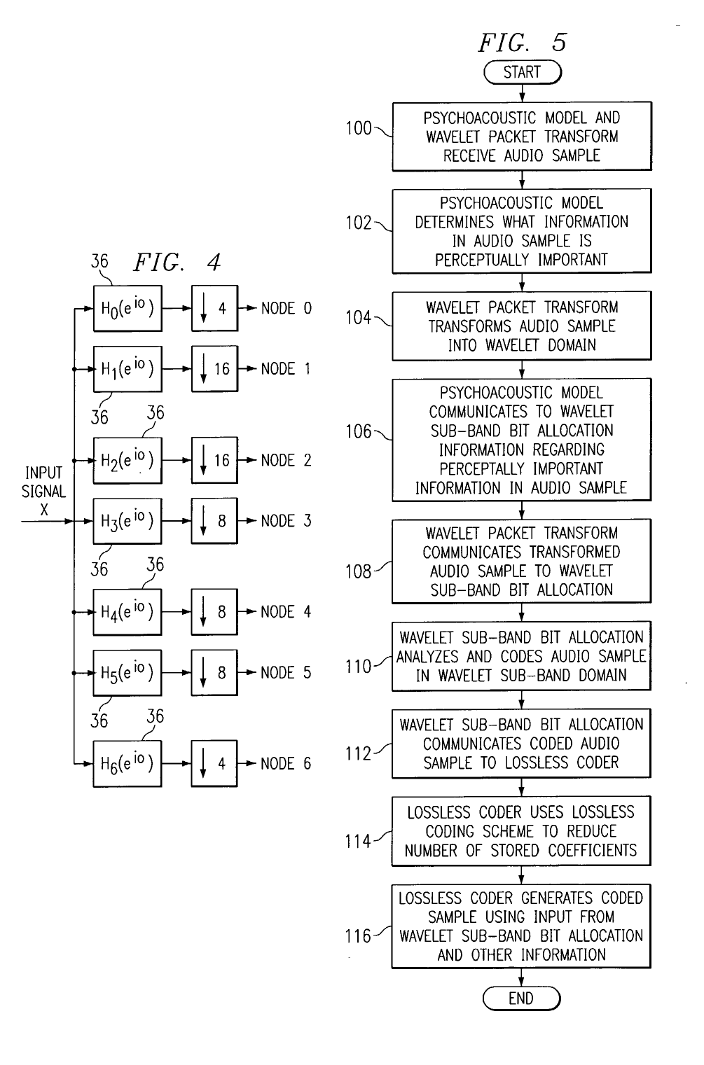

The Wavelet Transform may only decompose the coarse part, or low-pass channel, from each iteration of the filter bank. Wavelet Packet Transforms may provide the option of decomposing each branch. Using wavelet packets, various wavelet tree decompositions can be formed, including the wavelet transform. Herein, reference to Wavelet Packet Transform 14 encompasses the Wavelet Transform as a possible configuration, unless stated otherwise. Wavelet Packet Transform 14 may have a tree structure that corresponds to the critical bands of the human auditory system. The tree structure of Wavelet Packet Transform 14 may be rewritten as a parallel filter bank, such as the example parallel filter bank illustrated in FIG. 4. In the parallel filter bank structure, cascaded filters and decimators are combined to form an equivalent filter and decimator pair for a particular channel. In particular embodiments, a 32-band, parallel packet structure may be used.

1.1. ADAPTIVE TECHNIQUES

A non-adaptive Wavelet Packet Transform 14 may have a predetermined wavelet tree decomposition before the actual decomposition of audio sample 12 is performed. An adaptive Wavelet Packet Transform 14 may not need a predetermined wavelet tree decomposition 18. Rather, the wavelet tree decomposition 18 may be determined as the signal is being decomposed. With each iteration of a one-step transform 26, there is a low-channel and a high-channel output. A decision may be made to further decompose either channel based on certain criteria. In particular embodiments, a perceptual entropy measure may be used to determine whether to further decompose a particular channel. Perceptual entropy is a measure of the perceptually important information in a signal, as described below. If the perceptual entropy of the sum of the low-channel output and high-channel output is less than the perceptual entropy of the original node 28, the decomposed structure wherein the node is split into a high and low channel may provide better compression. In particular embodiments, an optimal tree structure, for example, 16, may be found for each audio sample in the audio sample set. This may increase overall compression. As an example, a particular implementation of Wavetablet coder 10 may have a computational constraint that allows a maximum of thirty-two sub-bands for the wavelet packet decomposition. The maximum size of the tree structure 16 may then have thirty-two sub-bands. An adaptive tree 16 may require fewer sub-bands than the maximum. A smaller adaptive tree 16 may produce better compression, and decrease computation time for both encoding and decoding. The worst case structure for an adaptive tree 16 for this example would have thirty-two sub-bands.

An adaptive Wavelet Packet Transform 14 may also determine which wavelet filter produces a best tree structure 16 for a particular audio sample. In certain embodiments, tree structure 16 of Wavelet Packet Transform 14 may be predetermined. Audio sample 12 may be analyzed with the prescribed tree structure 16 using many different wavelet filters. Different wavelet filters may provide better compression for a particular audio sample. In another embodiment, an adaptive tree structure 16, as described above, may also be used with a variety of wavelet filters. Certain wavelet filters may produce tree structures 16 that are different from tree structures 16 produced by other filters when a particular audio sample is analyzed using the adaptive approach described above. These wavelet filters may increase compression. Particular embodiments may search for the best wavelet filter at each iteration at each node 28. This may yield a tree structure 16 that has different wavelet filters at different levels of the tree 16. The different types of adaptive Wavelet Packet Transform 14 may increase coding complexity, but it may also provide significant gains in compression.

1.2. PSYCHOACOUSTIC MODEL

As illustrated in FIG. 1, psychoacoustic model 30 is used to analyze audio sample 12. This psychoacoustic analysis may be in parallel to Wavelet Packet Transform 14 or subsequent to it. As described more fully below, psychoacoustic model 30 receives audio sample 12, determines what information in audio sample 12 is perceptually important, and communicates that information to wavelet sub-band bit allocation 32. Perceptually based coding of audio sample 12 using psychoacoustic model 30 may be used to achieve high compression while maintaining the perceptual integrity of the original signal. International standards, such as Moving Picture Experts Group (MPEG), may in particular embodiments provide structures for psychoacoustic model 30. Psychoacoustic model 30 is based on properties of the human auditory system. The aim of psychoacoustic model 30 is to calculate a (time-varying) masking threshold for audio sample 12 that may be used by wavelet sub-band bit allocation 32.

Masking is the ability of a tone (or noise) to make neighboring tones (or noise) inaudible based on relative magnitude and proximity in the frequency domain. The masking threshold is used to determine how many bits are needed to encode a particular frequency sub-band without loss of perceptual quality. The number of bits needed to encode a particular frequency sub-band may also be used as the perceptual entropy of the audio signal at that particular frequency sub-band. In certain embodiments, the masking threshold may be calculated for frequency bands that are dependent on the sub-band structure created by Wavelet Packet Transform 14. In other embodiments, the masking threshold may be calculated for a predetermined set of frequency bands. The predetermined frequency band structure may be similar to the Bark-bands, which is a model of the critical band structure of the human auditory system. If the masking threshold is calculated for frequency band structures that are different from the structure created by Wavelet Packet Transform 14, appropriate modifications may be made to the output of psychoacoustic model 30, as described below.

1.3. BIT ALLOCATION

The outputs of psychoacoustic model 30 and Wavelet Packet Transform 14 are communicated to wavelet sub-band bit allocation 32. Wavelet sub-band bit allocation 32 may use the output of psychoacoustic model 30 to quantize the sub-bands generated by Wavelet Packet Transform 14. In certain embodiments, wavelet sub-band bit allocation 32 may use information from Wavelet Packet Transform 14 to determine the bit allocation for each sub-band. Wavelet sub-band bit allocation 32 may not need to modify the output of psychoacoustic model 30. Each sub-band of transformed audio sample 12 is then quantized. In another embodiment, psychoacoustic model 30 may use a frequency band partitioning different than Wavelet Packet Transform 14. Wavelet sub-band bit allocation 32 may then adjust the output of psychoacoustic model 30 to correspond to the sub-bands generated by Wavelet Packet Transform 14. Wavelet sub-band bit allocation 32 then quantizes the sub-bands from Wavelet Packet Transform 14.

1.4. OPTIONAL USE OF DIFFERENTIAL PULSE CODE MODULATION (DPCM)

A PCM audio sample 12 may be filtered using a linear finite impulse response (FIR) differencing filter (dpcm(i)=pcm(i)−pcm(i−1)), creating a DPCM audio sample prior to encoding. This DPCM audio sample may allow reconstruction back to PCM audio sample 12 using an infinite impulse response (IIR) filter (pcm(i)=pcm(i−1)+dpcm(i)), when seeded with correct initial values. For many audio samples, converting to DPCM may reduce the range by more than half. Wavelet coding may be applied to a DPCM audio sample in the same way as PCM audio sample 12. However, in particular embodiments, for perceptual coding, psychoacoustic model 30 may be adjusted appropriately to reflect that the data representation is different. Decompression may proceed as described above to recover the DPCM audio sample. The lossy nature of the coding may typically introduce some direct current (DC) drift which may be compensated for in various ways. A final DPCM to PCM recovery may be performed by a decoder or may be performed by an application.

1.5. ADDITIONAL COMPRESSION

Lossless coder 34 may provide additional compression by performing a run-length coding scheme on the output of wavelet sub-band bit allocation 32. The quantized wavelet domain coefficients may contain relatively long strings of zeros and ones (in binary). Run-length coding may increase compression. In addition or as an alternative to run-length coding, other lossless coding techniques, such as Huffman coding, may be implemented to provide additional compression. In addition or as a further alternative to these techniques, lossy coding techniques may be applied, so long as they do not leave a major psychoacoustic impact on the signals.

1.6. AUXILIARY INFORMATION

Auxiliary information noting the size, location, and other information (which may include the number of sub-bands used, which wavelet filter was used, the bit-allocation scheme used, the tree structure, and other appropriate information) may also be stored. Auxiliary information may also be compressed.

1.7. ENCODING

FIG. 5 illustrates an example method for wavelet-based compression of audio sample 12. The method begins at step 100, where psychoacoustic model 30 and Wavelet Packet Transform 14 both receive an audio sample 12. At step 102, psychoacoustic model 30 determines what information in audio sample 12 is perceptually important. To do this, psychoacoustic model 30 may calculate masking thresholds in the frequency domain of audio sample 12. At step 104, which may in particular embodiments occur at substantially the same time as step 102, Wavelet Packet Transform 14 transforms audio sample 12 into the wavelet domain. As described above, adaptive wavelet packet decomposition 16 may be used in particular embodiments as an alternative. Before Wavelet Packet Transform 14 transforms audio sample 12, a substantially optimal wavelet filter may, in particular embodiments, be identified for audio sample 12 that substantially maximizes the compression ratio and tree structure size for audio sample 12, as described above. In addition, wavelet packet decomposition 16 may perform a search for the best wavelet at each node 28 in tree structure 16, which may result in tree structure 16 having different wavelet analysis filters 36 at each node 28, as further described above.

At step 106, psychoacoustic model 30 communicates to wavelet sub-band bit allocation 32 data indicating the information in audio sample 12 that is perceptually important. At step 108, which may in particular embodiments occur at the same time as step 106, Wavelet Packet Transform 14 communicates to wavelet sub-band bit allocation 32 transformed audio sample 12. At step 110 wavelet sub-band bit allocation 32 analyzes and codes transformed audio sample 12 in the wavelet sub-band domain. As described above, each sub-band may be allocated a minimum number of bits (which may be determined by psychoacoustic model 30) without substantial loss of perceptual quality. At step 112, wavelet sub-band bit allocation 32 communicates coded audio sample 12 to lossless coder 34. At step 114, lossless coder 34 uses a lossless coding technique (such as a run-length coding technique) to reduce the number of coefficients that are stored, which may result in more efficient compression in the wavelet domain. At step 116, lossless coder 34 generates coded sample 38 using the input from wavelet sub-band bit allocation 32 and other information (which may include wavelet packet auxiliary information 40 from Wavelet Packet Transform 14), at which point the method ends.

2. DECODER

FIG. 6 illustrates an example Wavetablet decoder 42. As illustrated in FIG. 6, an audio sample request 44 is received, and an appropriate Wavetablet coded sample is selected from wave-tablet coded samples 46. The selected Wavetablet coded sample is then decoded based on how it was encoded. For example, any lossless (or lossy) compression technique, such as run-length coding, Huffman coding, etc., applied to the wavelet coefficients and any compression technique applied to wavelet packet auxiliary information 40 is “undone” by decoder 48. Bit unpacking 50 “unpacks” the bits of the wavelet sub-band coefficients. Inverse Wavelet Packet Transform 52 transforms the decoded wave-tablet sample according to the tree structure and filter types specified by the wavelet packet auxiliary information 54. The output of inverse Wavelet Packet Transform 52 is requested audio sample 56. If the original sample that was encoded was a DPCM audio sample, the output of inverse Wavelet Packet Transform 52 is also a DPCM audio sample.

2.1. DECODING

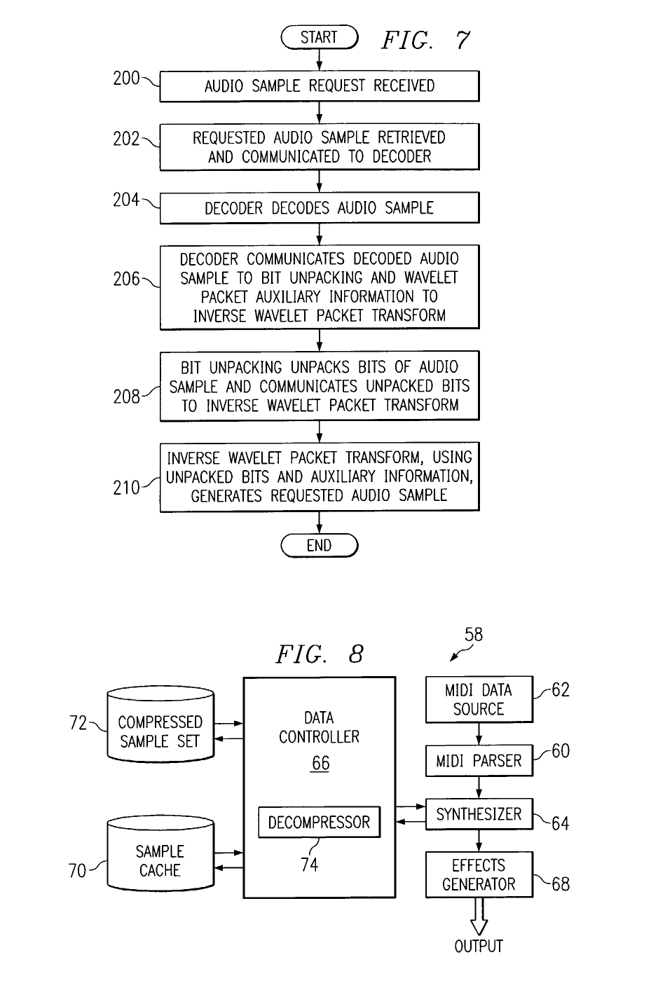

FIG. 7 illustrates an example method for wavelet-based decompression of a requested audio sample. The method begins at step 200, where an audio sample request 44 is received. At step 202, the requested audio sample is retrieved from wave-tablet coded samples 46 and communicated to decoder 48. At step 204, decoder 48 decodes the retrieved audio sample. At step 206, decoder 48 communicates the decoded audio sample to bit unpacking 50 and communicates wavelet packet auxiliary information 54 to inverse Wavelet Packet Transform 52. At step 208, bit unpacking 50 unpacks the bits of the decoded audio sample and communicates the unpacked bits to inverse Wavelet Packet Transform 52. At step 210, inverse Wavelet Packet Transform 52, using the unpacked bits and wavelet packet auxiliary information 54, generates requested audio sample 56, at which point the method ends.

3. MIDI EXAMPLE

In music synthesis terminology, a “sample” may include audio signals or other data that may be used to generate a particular sound, possibly across a range of pitches or tones. In this example, the term “sample” will be used in this way. FIG. 8 illustrates an example MIDI system 58 using Wave-tablet decoder 42. In particular embodiments, MIDI system 58 includes a MIDI parser 60, which may receive MIDI data from MIDI data source 62. MIDI data received by MIDI parser 60 may include any suitable data directing system 58 to generate particular output corresponding to a particular sound, such as a particular note played by a particular musical instrument. MIDI parser 60 receives MIDI data from MIDI data source 62, parses the received MIDI data, and communicates the parsed MIDI data to synthesizer 64. Synthesizer 64 receives the parsed MIDI data and requests a corresponding decompressed sample from data controller 66. Synthesizer 64 receives the requested decompressed sample from data controller 66 and may modify parameters such as the pitch and amplitude of the requested decompressed sample. Synthesizer 64 then outputs the decompressed sample to effects generator 68. Effects generator 68 receives the decompressed sample from synthesizer 64 modifies the received decompressed sample according to one or more effects, and provides the modified decompressed sample as output, which may in turn be used to generate a corresponding sound.

In particular embodiments, data controller 66 receives from synthesizer 64 a request for a decompressed sample and determines whether sample cache 70 includes the requested decompressed sample. Sample cache 70 may include a relatively small number of frequently requested decompressed samples. In these embodiments, sample cache 70 may include different decompressed samples over time as different decompressed samples are requested by synthesizer 64. If sample cache 70 includes the requested decompressed sample, data controller 66 may access the requested decompressed sample in sample cache 70 and communicate the sample to synthesizer 64. If sample cache 70 does not include the requested decompressed sample, data controller 66 may access a corresponding compressed sample in compressed sample set 72, decompress the sample using decompressor 74 (which may include Wave-tablet decoder 42), and communicate the sample to synthesizer 64. Compressed sample set 72 may include PCM or other data stored as persistent data and may include a substantially complete set of samples. When data controller 66 accesses a compressed sample and decompresses it in response to a request from synthesizer 64, data controller 66 may cache the decompressed sample and may, in doing so, displace one or more other decompressed samples in sample cache 70.

Although several embodiments of the present invention have been described, the present invention may encompass sundry changes, substitutions, variations, alterations, and modifications, and it is intended that the present invention encompass all those changes, substitutions, variations, alterations, and modifications falling within the spirit and scope of the appended claims.

What is claimed is:

1. A system for wavelet-based compression of an audio sample set comprising a plurality of audio samples:
the system operable, for each of the plurality of audio samples, to:
receive the audio sample;
according to a psychoacoustic model, determine perceptually important information in the audio sample;
according to a Wavelet Packet Transform, decompose the audio sample into a plurality of sub-bands;
allocate bits to each of the plurality of sub-bands of the audio sample according to the determined perceptually important information in the audio sample; and
compress the audio sample according to the allocation of bits to the sub-bands;
the plurality of compressed audio samples comprising a compressed audio sample set usable to generate a plurality of synthesized audio signals.

2. The system of claim 1, wherein:
the audio sample set comprises a wavetable sample set; and
the plurality of audio samples each comprise a wavetable audio sample.

3. The system of claim 2, wherein each wavetable sample is decomposed into a plurality of sub-bands, decomposition occurring at a particular node only if the decomposition results in an increased compression ratio.

4. The system of claim 3, wherein each wavetable sample is decomposed into thirty-two or fewer sub-bands.

5. The system of claim 4, wherein the decomposition of a wavetable sample is an optimal decomposition of the wavetable sample.

6. The system of claim 5, wherein the optimal decomposition of the wavetable sample is a result of a substantially exhaustive search over a substantially large space of wavelets, the search involving decomposing the wavetable sample with each wavelet at each node and selecting an optimal decomposition tree.

7. The system of claim 2, further operable to further compress each wavetable sample using a lossless coding technique.

8. The system of claim 7, wherein the lossless coding technique comprises one of a run-length coding technique and a Huffman coding technique.

9. The system of claim 2, wherein each wavetable sample comprises a pulse code modulated (PCM) signal.

10. The system of claim 2, wherein each wavetable sample comprises a differential pulse code modulated (DPCM) signal.

11. The system of claim 2, wherein the psychoacoustic model is based, at least in part, on a Moving Picture Experts Group (MPEG) psychoacoustic model.

12. The system of claim 1, wherein each audio sample is decomposed into a number of sub-bands, the decomposition of an audio sample corresponding to a particular wavelet decomposition tree comprising a plurality of nodes, a potentially different wavelet filter being usable at each node to produce an optimal wavelet decomposition tree with optimal wavelets at each node.

13. The system of claim 1, wherein the audio sample set comprises an audio sample set usable to synthesize speech.

14. A method for wavelet-based compression of an audio sample set comprising a plurality of audio samples:
the method comprising, for each of the plurality of audio samples:
receiving the audio sample;
according to a psychoacoustic model, determining perceptually important information in the audio sample;
according to a Wavelet Packet Transform, decomposing the audio sample into a plurality of sub-bands;
allocating bits to each of the plurality of sub-bands of the audio sample according to the determined perceptually important information in the audio sample; and
compressing the audio sample according to the allocation of bits to the sub-bands;
the plurality of compressed audio samples comprising a compressed audio sample set usable to generate a plurality of synthesized audio signals.

15. The method of claim 14, wherein:
the audio sample set comprises a wavetable sample set; and
the plurality of audio samples each comprise a wavetable audio sample.

16. The method of claim 15, wherein each wavetable sample is decomposed into a plurality of sub-bands, decomposition occurring at a particular node only if the decomposition results in an increased compression ratio.

17. The method of claim 16, wherein each wavetable sample is decomposed into thirty-two or fewer sub-bands.

18. The method of claim 17, wherein the decomposition of a wavetable sample is an optimal decomposition of the wavetable sample.

19. The method of claim 18, wherein the optimal decomposition of the wavetable sample is a result of a substantially exhaustive search over a substantially large space of wavelets, the search involving decomposing the wavetable sample with each wavelet at each node and selecting an optimal decomposition tree.

20. The method of claim 15, wherein the method further comprises compressing each wavetable sample using a lossless coding technique.

21. The method of claim 20, wherein the lossless coding technique comprises one of a run-length coding technique and a Huffman coding technique.

22. The method of claim 15, wherein each wavetable sample comprises a pulse code modulated (PCM) signal.

23. The method of claim 15, wherein each wavetable sample comprises a differential pulse code modulated (DPCM) signal.

24. The method of claim 15, wherein the psychoacoustic model is based, at least in part, on a Moving Picture Experts Group (MPEG) psychoacoustic model.

25. The method of claim 14, wherein each audio sample is decomposed into a number of sub-bands, the decomposition of an audio sample corresponding to a particular wavelet decomposition tree comprising a plurality of nodes, a potentially different wavelet filter being usable at each node to produce an optimal wavelet decomposition tree with optimal wavelets at each node.

26. The method of claim 14, wherein the audio sample set comprises an audio sample set usable to synthesize speech.

27. A system for wavelet-based decompression of a compressed audio sample, the system operable to:
receive a request for a decompressed audio sample, the decompressed audio sample corresponding to the compressed audio sample, the compressed audio sample having been compressed by:
according to a psychoacoustic model, determining perceptually important information in a received audio sample;
according to a Wavelet Packet Transform, decomposing the received audio sample into a plurality of sub-bands;
allocating bits to each of the plurality of sub-bands of the received audio sample according to the determined perceptually important information in the received audio sample; and
compressing the received audio sample according to the allocation of bits to the sub-bands;
retrieve the compressed audio sample from a compressed audio sample set comprising a plurality of similarly compressed audio samples;
unpack the retrieved compressed audio sample; and
according to an inverse Wavelet Packet Transform, compose the decompressed audio sample from the plurality of sub-bands for use in generating a synthesized audio signal.

28. The system of claim 27, wherein the received audio sample comprises a wavetable audio sample.

29. The system of claim 28, wherein the wavetable audio sample has been decomposed into a plurality of sub-bands, decomposition occurring at a particular node only if the decomposition results in an increased compression ratio.

30. The system of claim 29, wherein the compressed wavetable audio sample has been decomposed into thirty-two or fewer sub-bands.

31. The system of claim 30, wherein the decomposition of the wavetable audio sample has been an optimal decomposition of the wavetable audio sample.

32. The system of claim 31, wherein the optimal decomposition of the wavetable audio sample has been a result of a substantially exhaustive search over a substantially large space of wavelets, the search involving decomposing the wavetable audio sample with each wavelet at each node and selecting an optimal decomposition tree.

33. The system of claim 28, wherein the wavetable audio sample has been further compressed using a lossless coding technique.

34. The system of claim 33, wherein the lossless coding technique comprises one of a run-length coding technique and a Huffman coding technique.

35. The system of claim 28, wherein the wavetable audio sample comprises a pulse code modulated (PCM) signal.

36. The system of claim 28, wherein the wavetable audio sample comprises a differential pulse code modulated (DPCM) signal.

37. The system of claim 28, wherein the psychoacoustic model is based, at least in part, on a Moving Picture Experts Group (MPEG) psychoacoustic model.

38. The system of claim 27, wherein each audio sample has been decomposed into a number of sub-bands, the decomposition of an audio sample corresponding to a particular wavelet decomposition tree comprising a plurality of nodes, a potentially different wavelet filter being usable at each node to produce an optimal wavelet decomposition tree with optimal wavelets at each node.

39. The system of claim 27, wherein the decompressed audio sample is usable to synthesize speech.

40. The system of claim 27, wherein the system comprises an audio device operable to generate one or more sounds using the decompressed audio sample.

41. A method for wavelet-based decompression of a compressed audio sample, the method comprising:
receiving a request for a decompressed audio sample, the decompressed audio sample corresponding to the compressed audio sample, the compressed audio sample having been compressed by:
according to a psychoacoustic model, determining perceptually important information in a received audio sample;
according to a Wavelet Packet Transform, decomposing the received audio sample into a plurality of sub-bands;
allocating bits to each of the plurality of sub-bands of the received audio sample according to the determined perceptually important information in the received audio sample; and
compressing the received audio sample according to the allocation of bits to the sub-bands;
retrieving the compressed audio sample from a compressed audio sample set comprising a plurality of similarly compressed audio samples;
unpacking the retrieved compressed audio sample; and
according to an inverse Wavelet Packet Transform, composing the decompressed audio sample from the plurality of sub-bands for use in generating a synthesized audio signal.

42. The method of claim 41, wherein the received audio sample comprises a wavetable audio sample.

43. The method of claim 42, wherein the wavetable audio sample has been decomposed into a plurality of sub-bands, decomposition occurring at a particular node only if the decomposition results in an increased compression ratio.

44. The method of claim 43, wherein the compressed wavetable audio sample has been decomposed into thirty-two or fewer sub-bands.

45. The method of claim 44, wherein the decomposition of the wavetable audio sample has been an optimal decomposition of the wavetable audio sample.

46. The method of claim 45, wherein the optimal decomposition of the wavetable audio sample has been a result of a substantially exhaustive search over a substantially large space of wavelets, the search involving decomposing the wavetable audio sample with each wavelet at each node and selecting an optimal decomposition tree.

47. The method of claim 42, wherein the wavetable audio sample has been further compressed using a lossless coding technique.

48. The method of claim 47, wherein the lossless coding technique comprises one of a run-length coding technique and a Huffman coding technique.

49. The method of claim 42, wherein the wavetable audio sample comprises a pulse code modulated (PCM) signal.

50. The method of claim 42, wherein the wavetable audio sample comprises a differential pulse code modulated (DPCM) signal.

51. The method of claim 42, wherein the psychoacoustic model is based, at least in part, on a Moving Picture Experts Group (MPEG) psychoacoustic model.

52. The method of claim 41, wherein each audio sample has been decomposed into a number of sub-bands, the decomposition of an audio sample corresponding to a particular wavelet decomposition tree comprising a plurality of nodes, a potentially different wavelet filter being usable at each node to produce an optimal wavelet decomposition tree with optimal wavelets at each node.

53. The method of claim 41, wherein the decompressed audio sample is usable to synthesize speech.

54. The method of claim 41, further comprising using an audio device operable to generate one or more sounds using the decompressed audio sample.

55. A system for wavelet-based decompression of a compressed audio sample, the system comprising an audio device operable to generate one or more sounds using a decompressed audio sample and operable to:
receive a request for a decompressed audio sample, the decompressed audio sample corresponding to the compressed audio sample, the compressed audio sample having been compressed by:
determining perceptually important information in a received audio sample according to a psychoacoustic model, the received audio sample comprising a wavetable audio sample, the psychoacoustic model being based at least in part on a Moving Picture Experts Group (MPEG) psychoacoustic model;
according to a Wavelet Packet Transform, decomposing the received audio sample into a plurality of sub-bands, decomposition occurring at a particular node only if the decomposition results in an increased compression ratio, the decomposition of the received audio sample being an optimal decomposition of the received audio sample, the optimal decomposition being a result of a substantially exhaustive search over a substantially large space of wavelets, the search involving decomposing the received audio sample with each wavelet at each node and selecting an optimal decomposition tree;
allocating bits to each of the plurality of sub-bands of the received audio sample according to the determined perceptually important information in the received audio sample; and
compressing the received audio sample according to the allocation of bits to the sub-bands;
retrieve the compressed audio sample from a compressed audio sample set comprising a plurality of similarly compressed audio samples;
unpack the retrieved compressed audio sample; and
according to an inverse Wavelet Packet Transform, compose the decompressed audio sample from the plurality of sub-bands for use in generating a synthesized audio signal.
